(19) United States
(12) Patent Application Publication
(10) Pub. No.: US 2015/0201064 A1
(43) Pub. Date: Jul. 16, 2015

(54) METHODS AND APPARATUS TO DETECT AND ADD IMPACT EVENTS TO A CALENDAR PROGRAM

(71) Applicants: Matthew Bells, Kanata (CA); Yuqi Edwin Gao, Surrey (CA)

(72) Inventors: Matthew Bells, Kanata (CA); Yuqi Edwin Gao, Surrey (CA)

(73) Assignee: BLACKBERRY LIMITED, Waterloo, ON (CA)

(21) Appl. No.: 14/409,627

(22) PCT Filed: Jun. 26, 2012
(86) PCT No.: PCT/CA2012/050425

§ 371 Date: Dec. 19, 2014

(51) Int. Cl. H04M 1/725; G06Q 10/10

(52) U.S. Cl. CPC H04M 1/72566; G06Q 10/1095

(57) ABSTRACT

A calendaring method involves receiving a command to enter calendar event data, in a calendar program that stores calendar data running on a processor of a wireless mobile device; determining, from the calendar event data, a location and a date associated with the calendar event; searching a database for impact event data associated with an impact event occurring at or about the location and on or about the date; after indentifying the impact event data, storing linking data, linking the calendar event and the impact event in the calendar program's calendar data.

### BACKGROUND

Users of electronic communication devices, including mobile or wireless devices such as smart phones, mobile phones, tablets and personal digital assistants or PDAs, have access to a number of convenient and useful applications installed on their electronic communication devices. Email, calendar, Web browser and Internet search applications are some examples.

People who travel for business or pleasure or who have other international dealings commonly track and plan their activities by use of a calendar program installed on a portable wireless device.

### BRIEF DESCRIPTION OF THE DRAWINGS

Example embodiments of the present disclosure will be described below with reference to the included drawings such that like reference numerals refer to like elements and in which:

FIG. 1 is a block diagram of a communications system that includes a search engine server, a communications network, and various communication devices, in accordance with various example embodiments of the present disclosure;

FIG. 2 is a detailed block diagram of an example mobile communication device, in accordance with various example embodiments of the present disclosure;

FIG. 3 illustrates an example user interface of a communication device, in accordance with various example embodiments of the present disclosure;

FIG. 4 illustrates applications that may be stored in a memory of a communication device, in accordance with various example embodiments of the present disclosure; and

FIG. 5 illustrates a flow illustrative of an example method in accordance with methods consistent with the present disclosure.

### DETAILED DESCRIPTION

The various examples presented herein outline methods, user interfaces, and electronic devices and associated servers that provide a user with valuable information about holidays and other events occurring at a location associated with a calendar even to be taken into consideration when planning such an event.

For simplicity and clarity of illustration, reference numerals may in some instances be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limiting on the scope of the embodiments described herein.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or “application” or “app” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library / dynamic load library and/or other sequence of instructions designed for execution on a computer system. The term “processor”, “controller”, “CPU”, “Computer” and the like as used herein encompasses both hard programmed, special purpose, general purpose and programmable devices and may encompass a plurality of such devices or a single device in either a distributed or centralized configuration without limitation.

Reference throughout this document to “one embodiment”, “certain embodiments”, “an embodiment”, “an implementation”, “an example” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein, the term “calendar event” is intended to mean any item that is entered and saved as data to a calendar program such as for example scheduled meetings, phone calls, conference calls, travel plans, birthdays, anniversaries, etc. The term “impact event” is intended to mean an event occurring at or about the location and at or about the date of the calendar event that may impact the calendar event. In some example embodiments, impact events are events that occur at the same address, city, province, state, country, or within a predetermined distance from the address of the calendar event. In some example embodiments, impact events occur on the same date as the calendar event, during the same week as the calendar event, during the same month as the calendar event, or within a predetermined number of days before and after the calendar event. For example, an impact event can include, but is not limited to, a bank holiday; a federal, state regional or local holiday (including a government or religious holiday, or a company holiday, etc.); scheduled road, transit, train ferry, bridge or airport closures; festivals that might affect traffic or hotel availability; general strikes; major sporting events or celebrations that might affect traffic or hotel availability; Olympic Games; parades; war or conflict; protests; natural disasters; man made disasters; accidents; etc. The impact event may occur at or about the time of the calendar event so as to potentially affect travel, hotel availability, business closures, transportation systems and the like at the time and location of the calendar event.

A method consistent with certain example implementations involves receiving a command to enter calendar event data, in a calendar program that stores calendar data running on a processor of a wireless mobile device; determining, from the calendar event data, a location and a date associated with the calendar event; searching a database for impact event data associated with an impact event occurring at or about the location and on or about the date; and after identifying the impact event data, storing linking data, linking the calendar event and the impact event in the calendar program's calendar data.

A search engine server consistent with certain implementation is coupled to a communications network that facilitates identification of impact events impacting a calendar event. A database is provided and a processor is coupled to the database and configured to: after receiving a search query for a specified date in a specified location, return impact event data associated with an impact event occurring at or about the specified location and on or about the specified date.

In certain implementations, the impact event can be a holiday at the location. In certain implementations, the impact event can be an event known to affect transportation or lodging at the location. In certain implementations, the search query is initiated by a wireless mobile device in communication with the search engine server.

A wireless mobile device consistent with certain implementations has a calendar program configured to store and manage calendar data. A processor is configured to: receive an input to enter calendar event data; determine from the calendar event data, a location and a date associated with the event; search a database for impact event data associated with an impact event occurring at or about the location and on or about the date; after identifying the impact event data; and store linking data, linking the calendar event and the linked impact event in the calendar program's calendar data.

In certain implementations, the impact event can be a holiday at the location or an event known to affect transportation or lodging at the location, In certain implementations, the database resides at a remote server in wireless communication with the wireless mobile device. In certain implementations, the processor is configured to generate and display a list of possible locations determined from the calendar event for selection of a correct location. In certain implementations, the processor is configured to place the list of possible locations in an order for display, with the order of the list being determined at least in part by at least one of :communication history of the wireless mobile device, a location history of the wireless mobile device, frequency of travel from a current location or a home location of the wireless mobile device, reference to a contact in a contact database, where the contact is determined from the calendar event, or a city size.

In certain implementations, the processor is configured to generate an alert of potential conflict between the calendar event and the impact event. In certain implementations, the alert includes a link to a service or details of the impact event or news relating to the impact event. In certain implementations, the processor is configured to generate a display of an auto-complete box of possible locations from which a correct location can be selected.

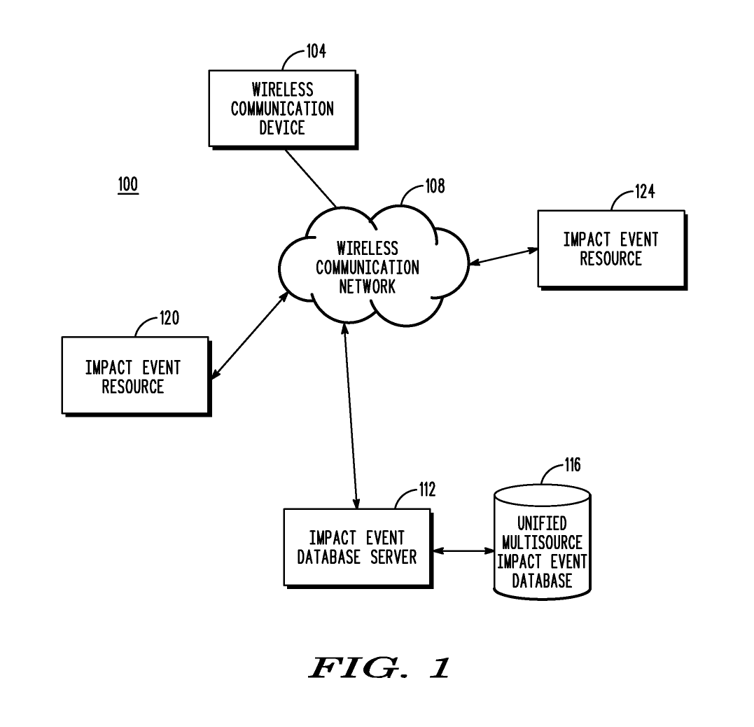

Referring now to FIG. 1, a block diagram of a distributed communications system 100 that includes a wireless mobile device 104 that communicates with other wireless mobile devices (not shown) as well as wired devices via a communications network 108 that may integrate a number of communication networks such as the World Wide Web or Internet and wireless communication networks such as cellular communication networks. An impact event database server 112 is also connected to the communication network 108 and may reside on the World Wide Web. It is understood that the event database server and wireless mobile communication devices such as 104 may be coupled together by various types of networks, such as local area networks (LANs), cellular telephone data networks, other wide area networks (WANs) and regional networks accessed over telephone lines, such as commercial information services.

Impact event database server 112 may include a processor, communication interfaces, memory, etc. along with an impact event database 116, shown as a unified multisource holiday database. The impact event database server 112 is able to communicate with the communications network 108 to permit the database server to retrieve and store impact events into database 116 from various impact event resources 120 and 124, for example, and may permit manual entry of such events or collection of submitted impact events or impact events mined from known resources. Impact event resources can include government and private web sites, service provider resources, corporate enterprise servers, as well as other resources that are given access to directly upload events to the impact event database 116 that may qualify as impact events.

Hence, in certain implementations consistent with the present disclosure, the impact event database can be realized as a unified multisource database 116. Equipment manufacturers and service providers can implement impact event databases or resources as a part of the services provided to customers. Companies with enterprise services such as the Blackberry Enterprise Services (BES) used by Research In Motion Limited, Ontario, Canada could have their own database in addition. Service providers, corporate web services, government entities, or other providers could also provide calendars. Large-scale aggregation of the data stored in the database may be useful. In an example embodiment, a single provider can act as a centralized resource of the data used by a particular user and can aggregate relevant impact events from multiple sources to make them accessible to their users.

Example device 104 is a two-way electronic communication device having at least data and possibly also voice communication capabilities, and the capability to communicate with other communication devices or computer systems, for example, via the Internet. A communication device 104 may further be a mobile or handheld electronic device. Depending on the functionality provided by the electronic communication device, in the various example embodiments described herein, the device 104 may be a data communication device, a multiple-mode communication device configured for both data and voice communication, a smart phone, a mobile telephone or a personal digital assistant PDA (personal digital assistant) enabled for wireless communication, or a computer system with a wireless modem. Other examples of mobile electronic devices include mobile, or handheld, wireless communication devices such as pagers, cellular phones, cellular smart-phones, wireless organizers, wirelessly enabled notebook computers, tablets and so forth.

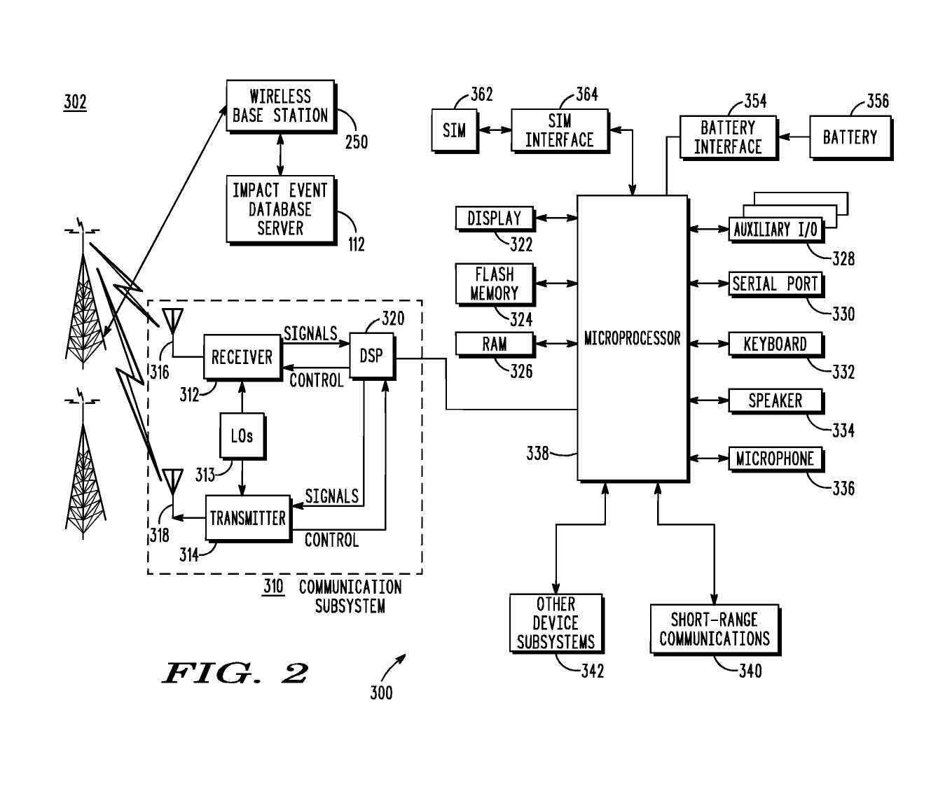

To illustrate an example of a system architecture, FIG. 2 shows a block diagram of a wireless communication system 302 which includes an electronic communication device 300, such as a wireless or mobile communication device 104, which communicates through a wireless communication network and ultimately to a base station 250 which is in communication with an impact event database server 112, as previously discussed in FIG. 1. Mobile communication device 300 may be a two-way communication device having at least voice and advanced data communication capabilities, including the capability to communicate with other computer systems. Depending on the functionality provided by mobile communication device 300, it may be referred to as a data messaging device, a two-way pager, a cellular telephone with data messaging capabilities, a smart phone, a wireless Internet appliance, or a data communication device (with or without telephony capabilities). Mobile communication device 300 may communicate with any one of a plurality of fixed transceiver stations 302 within its geographic coverage area.

Mobile communication device 300 will normally incorporate a communication subsystem 310, which includes a receiver 312, a transmitter 314, and associated components, such as one or more (which may be embedded or internal) antenna elements 316 and 318, local oscillators (LOs) 313, and a processing module such as a digital signal processor (DSP) 320. As will be apparent to those skilled in field of communications upon consideration of the present teachings, the particular design of communication subsystem 310 depends on the communication network in which mobile communication device 300 is intended to operate.

Mobile communication device 300 may send and receive communication signals over the network after required network registration or activation procedures have been completed. Signals received by antenna 316 through the network are input to receiver 312, which may perform such common receiver functions as signal amplification, frequency down conversion, filtering, channel selection, analog-to-digital (A/D) conversion and the like. A/D conversion of a received signal allows more complex communication functions such as demodulation and decoding to be performed in DSP 320. In a similar manner, signals to be transmitted are processed, including modulation and encoding, for example, by DSP 320. These DSP-processed signals are input to transmitter 314 for digital-to-analog (D/A) conversion, frequency up conversion, filtering, amplification and transmission over communication network via antenna 318. DSP 320 not only processes communication signals, but also provides for receiver and transmitter control. For example, the gains applied to communication signals in receiver 312 and transmitter 314 may be adaptively controlled through automatic gain control algorithms implemented in DSP 320.

Network access is associated with a subscriber or user of mobile communication device 300, and therefore mobile communication device 300 may use a Subscriber Identity Module or “SIM” card 362 to be inserted in a SIM interface 364 in order to operate in the network in a known manner. Example mobile communication device 300 is a battery-powered device so it also includes a battery interface 354 for receiving one or more rechargeable batteries 356. Such a battery 356 provides electrical power to most if not all electrical circuitry in mobile communication device 300, and battery interface 354 provides for a mechanical and electrical connection for it. The battery interface 354 is coupled to a regulator (not shown) which provides a regulated voltage V to all of the circuitry.

Mobile communication device 300 includes a microprocessor 338 which controls overall operation of mobile communication device 300. Communication functions, including at least data and voice communications, are performed through communication subsystem 310. The communication techniques of the present disclosure may generally be controlled by microprocessor 338 in connection with DSP 320. Microprocessor 338 also interacts with additional device subsystems such as a display 322, a flash memory 324, a random access memory (RAM) 326, auxiliary input/output (I/O) subsystems 328, a serial port 330, a keyboard 332, a speaker 334, a microphone 336, a short-range communications subsystem 340, and any other device subsystems generally designated at 342. Some of the subsystems perform communication-related functions, whereas other subsystems may provide “resident” or on-device functions. Notably, some subsystems, such as keyboard 332 and display 322, for example, may be used for both communication-related functions, such as entering a text message for transmission over a communication network, and device-resident functions such as a calculator or task list. Operating system software used by microprocessor 338 may be stored in a persistent store such as flash memory 324, which may alternatively be a read-only memory (ROM) or similar storage element (not shown). Those skilled in the art will appreciate upon consideration of the present teachings that the operating system, specific device applications, or parts thereof, may be temporarily loaded into a volatile store such as RAM 326.

Microprocessor 338, in addition to its operating system functions, enables execution of software applications on mobile communication device 300. A set of applications which control basic device operations, including at least data and voice communication applications, will normally be installed on mobile communication device 300 during its manufacture. An application that may be loaded onto mobile communication device 300 may be a personal information manager (PIM) application having the ability to organize and manage data items relating to user such as, but not limited to, e-mail, calendar events (as will be described later), voice mails, appointments, and task items. Generally speaking, the calendar function discussed herein is carried using the calendar portion of the PIM application.

One or more memory stores are available on mobile communication device 300 and SIM 356 to facilitate storage of PIM data items and other information. The PIM application has the ability to send and receive data items via the wireless network. In the present disclosure, PIM data items are seamlessly integrated, synchronized, and updated via the wireless network, with the mobile device user's corresponding data items stored or associated with a host computer system thereby creating a mirrored host computer on mobile communication device 300 with respect to such items. This is especially advantageous where the host computer system is the mobile communication device user's office computer system. Additional applications may also be loaded onto mobile communication device 300 through network, an auxiliary I/O subsystem 328, serial port 330, short-range communications subsystem 340, or any other suitable subsystem 342, and installed by a user in RAM 326 or a non-volatile store (not shown) for execution by microprocessor 338. Such flexibility in application installation increases the functionality of mobile communication device 300 and may provide enhanced on-device functions, communication-related functions, or both. For example, secure communication applications may enable electronic commerce functions and other such financial transactions to be performed using mobile communication device 300.

In a data communication mode, a received signal such as a text message, an e-mail message, or web page download will be processed by communication subsystem 310 and input to microprocessor 338. Microprocessor 338 will further process the signal for output to display 322 or alternatively to auxiliary I/O device 328. A user of mobile communication device 300 may also compose data items, such as e-mail messages and calendar events, for example, using-keyboard 332 in conjunction with display 322 and possibly auxiliary I/O device 328. Keyboard 332 may be a complete alphanumeric keyboard or telephone-type keypad. These composed items may be transmitted over a communication network through communication subsystem 310. For voice communications, the overall operation of mobile communication device 300 is substantially similar, except that the received signals would be output to speaker 334 and signals for transmission would be generated by microphone 336. Alternative voice or audio I/O subsystems, such as a voice message recording subsystem, may also be implemented on mobile communication device 300. Although voice or audio signal output may be accomplished primarily through speaker 334, display 322 may also be used to provide an indication of the identity of a calling party, duration of a voice call, or other voice call related information, as some examples.

Serial port 330 in FIG. 2 may be implemented in a personal digital assistant (PDA)-type communication device for which synchronization with a user's desktop computer is a useful, albeit optional, component. Serial port 330 enables a user to set preferences through an external device or software application and extends the capabilities of mobile communication device 300 by providing for information or software downloads to mobile communication device 300 other than through a wireless communication network. The alternate download path may, for example, be used to load an encryption key onto mobile communication device 300 through a direct and thus reliable and trusted connection to thereby provide secure device communication. Short-range communications subsystem 340 of FIG. 2 is an additional component which provides for communication between mobile communication device 300 and different systems or devices, which need not necessarily be similar devices.

In FIG. 2, the impact event database server is shown to be in communication with the wireless base station 250. In this example, the impact event database server 112 is accessed using, for example, 3G or 4G data communication provided by a wireless telephone system. However, this should not be considered limiting since the device 300 could also access the impact event database server via any suitable wired or wireless communication protocol including short range communications 340, serial port 330 or other communication interface connections such as universal serial port (USB), wired or wireless Ethernet or other connections provided to the device 300.

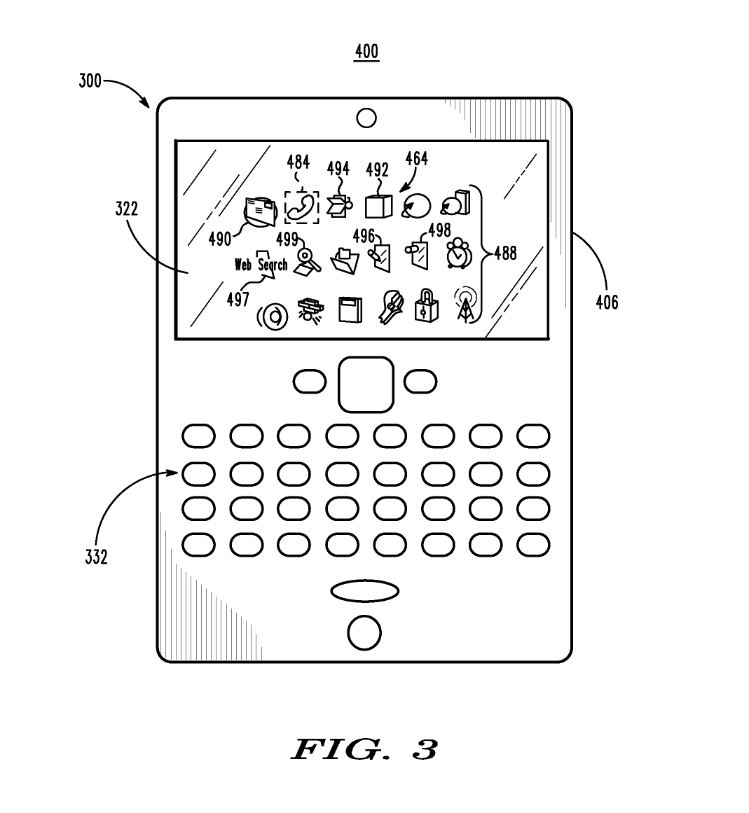

Referring now to FIG. 3, what is shown is an illustrative representation 400 of an example mobile communication device 300 of FIG. 2 which includes at least display 322 and a keyboard 332. Although shown enlarged in FIG. 3 for clarity, this mobile communication device 300 is sized to be a handheld portable device. A wide range of one or more pointing or cursor/view positioning mechanisms such as a touch pad a joystick button, a mouse, a touchscreen, a tablet, or other whether presently known or unknown, may be employed. The cursor may be or include a pointer, a movable item or other visual cue used to mark a position or point to another item on a display, in order to, for example, indicate position for data entry or for selection of the other item.

The keys of keyboard 332 are disposed on a front face of a housing 406. Keyboard 332 is in the example form of a reduced QWERTY keyboard including a plurality of keys that serve as input members. Keyboard 332 may be of other configurations, such as an AZERTY keyboard, a QWERTZ keyboard, a Dvorak keyboard, or other keyboard or keypad arrangement, and either reduced or not reduced (i.e. full). In a “full” or non-reduced keyboard or keypad arrangement, each key has a single letter (not multiple letters) of the alphabet assigned to it.

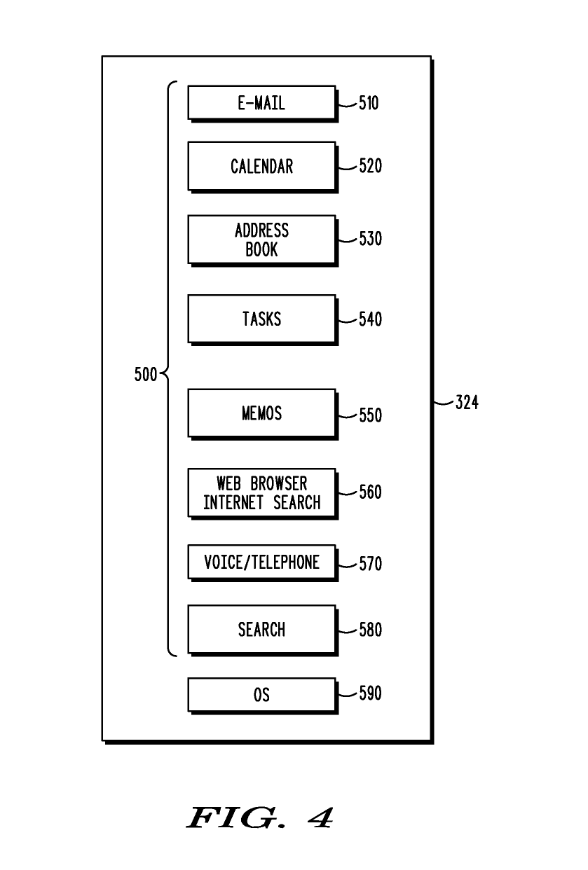

Among keys of keyboard 332 is a <RETURN> or <ENTER> key. The <RETURN> or <ENTER> key, for example, may be a symbol (such as an arrow) or it may be the word “RETURN” or “ENTER” provided (e.g. printed) on the key, and may be pressed to provide a selection input to the processor. Display 322 may include a cursor that depicts generally where the next input or selection from the user interface will be received. Display 322 is shown in FIG. 3 as displaying a home screen that represents a number of applications 500 (FIG. 4) depicted as corresponding discrete icons 488. Icons 488 include, for example, an Electronic Mail (E-Mail) icon 490, a Calendar icon 492, an Address Book icon 494, a Tasks icon 496, a Web browser/search application icon 497, a MemoPad icon 498, and a Local Device Search icon 499, respectively.

As shown further in FIG. 4, memory 324 of mobile communication device 300 includes a plurality of applications or routines 500 associated with the visually displayed icons 488 of FIG. 3 for the processing of data. Applications 500 may be in any of a variety of forms such as, without limitation, software, firmware, and the like. Applications 500 include, for example, an Electronic Mail (E-Mail) application 510 (FIG. 4) associated with E-mail icon 490 (FIG. 3), a Calendar application 520 (FIG. 4) associated with Calendar icon 492 (FIG. 3), an Address Book application 530 (FIG. 4) associated with Address Book icon 494 (FIG. 3), a Tasks application 540 (FIG. 4) associated with Tasks icon 496 (FIG. 3), a MemoPad (Memos) application 550 (FIG. 4) associated with MemoPad icon 498, a Web Browser or search application 560 (FIG. 4) associated with Web Browser/Search Application icon 497 (FIG. 3), a Voice/Telephone application 570 (FIG. 4) associated with Voice/Telephone icon 484, and a Local Device Search application 580 (FIG. 4) associated with Local Device Search icon 499 (FIG. 3). An operating system (OS) program 590 also resides in memory 324.

In FIG. 3, the “home” screen output is shown as currently active and constitutes the main application for displaying the icons 488 shown. An application, such as E-mail application 510 or Calendar application 520 of FIG. 4, may then be initiated (opened or viewed) by providing a suitable user input to it. For example, Calendar application 520 may be initiated (opened or viewed) by controlling a positioning mechanism to cause the Calendar 492 to be highlighted and selected. As another example, display 322 displays icon 499 associated with Search application 580 and accepts similar inputs from the positioning mechanism to initiate a search from that icon 499. Applications 500 may be additionally or alternatively initiated (opened or viewed) by providing similar inputs through the positioning mechanism.

Although a generic mobile communication device 300 has just been described, any suitable mobile communication device or terminal may be part of the inventive methods and apparatus which will be described in fuller detail below. Note that many components of mobile device 202 shown and described may not be included (e.g. a full QWERTY keypad may be optional or may be implemented as a virtual keyboard).

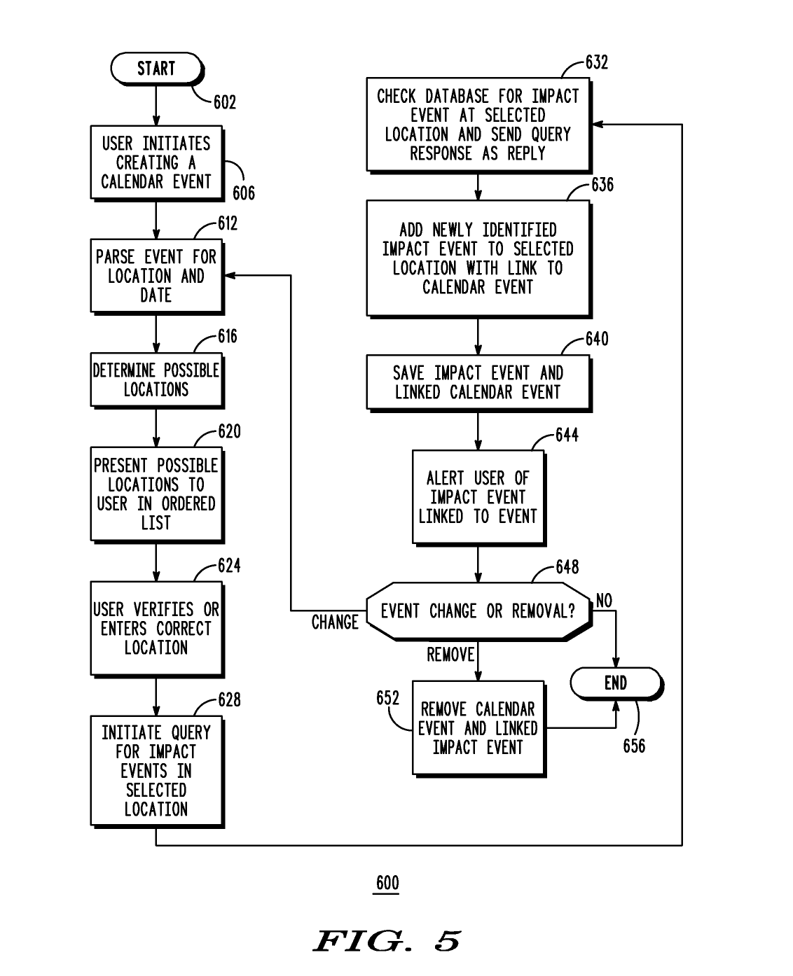

Tuning now to FIG. 5, a flow chart 600 depicts an implementation of an example embodiment consistent with the present disclosure. In this example, the method starts at 602 after which a user initiates entry of a calendar event into the calendar program of the communication device at 606, e.g., by invoking calendar application 520 and navigating to a date and time using the electronic device's navigation capabilities, such as “Jan. 1, 2012, 10:00 AM” for which the calendar event is to be stored as calendar event data. This initiates the creation of the calendar event. Once the user has entered information into the calendar such as “meeting in London with George Scott”, the information entered, the calendar program parses the information at 612 to determine a location and date and any other relevant information that may be used to determine the presence of an impact event. In this case, key information includes the date, the word “London” and the name “George Scott”. These terms can then be used to initiate a query of both locally stored information as well as information stored in the communication device or stored in the impact event database 116.

But, prior to initiating a query for impact events, it may be the case that some of the data can be interpreted in an ambiguous manner. For example, the term “London” might mean “London, England” or it might mean “London, Ontario” or any of many other cities and towns named “London” throughout the world. Generally speaking, one might expect the most likely location to be London, England, but in the event “George Scott” works or lives in London, Ontario, this may be the more likely answer. The address or other data regarding George Scott can be obtained from local contacts or from various global address list functions. In other cases, if the user of the communication device stores a history of meetings and travel to London, England, or if the most common destination from the nearest airport to home or the electronic device's current location is London, England, this data can be used to determine a most likely “London”. Further, since London, England is the largest city named “London”, it may always be considered to be a high probability while smaller cities would generally be considered to have a lower likelihood. One or more of these techniques can be used at 616 to determine a listing of likely locations.

In order to assure that the proper “London” is used, the communication device can at 620 present the user with a list of possible “London” locations from which the user can verify the location. The above factors can be used to present the user with an ordered listing of possible “London” locations with the most likely possibilities being situated at or near the top of the list for the user to select from at 624. That is, any number of factors can be used to order and prioritize the list including but not limited to one or more of the following factors: communication history of the wireless mobile device; location history of the wireless mobile device; size of location; frequency of travel from a current location or a home location of the wireless mobile device; or by reference to a contact in a contact database, where the contact is determined from the calendar event. Other factors may also be used to assist in determining which location is among the most likely actual location.

In this example, a query can be sent at 628 once the location has been verified by the user. Such query should include a date and a geographic location. In this example, regardless of which of the two example locations are selected by the user, the date is New Years Day, and impact event data is identified in the impact event database 116. The impact event data is sent to the communication device as a reply to the query at 632. At 636, the impact event is linked to the calendar event (so long as the calendar event remains on this date) and the calendar event and impact event are saved to the calendar at 640, concluding entry of the calendar event.

Since an impact event has been located, a warning message is generated to warn the user that this date is a holiday for the selected location at 644. The warning may be as simple or complex as desired. For example, the warning may simply state “New Years Day” or “Your newly calendared event occurs on New Years Day, a national holiday at the calendared location”. Or, the warning may provide much more detail, such as “Your newly calendared event occurs on New Years Day, a national holiday at the calendared location. Expect heavy traffic, airport congestion and high hotel occupancy, crowded subway, banks and other businesses closed, high alert for terrorism.” Further details of potential problems can be provided as are available in the database 116. The user may already be aware of the potential problem or may be newly alerted to the potential for business closures, travel difficulties, etc.

In light of the warnings, the user can make an educated decision regarding the scheduling of the event and if he/she chooses to change the event at 648, now or at a future time, the event can be edited in a conventional manner which passes or returns the user to 612 if a new date or location is selected.

If the user chooses to cancel or delete the calendared event at 652, in this implementation, the impact event and the calendared event are both removed from the calendar data. This minimizes cluttering the calendar, but in other implementations, once an impact event is calendared, it may be retained at the option of the user or as a default event that is calendared for future reference. The method then returns to await the next calendar entry at 656. In the event the user wishes to make no changes at 652, the method also ends at 656.

So long as the calendar event remains on the same date (regardless of time changes) the impact event remains linked to the calendar event. For example, if the time of the calendar event is moved from 10:00 AM to 11:00 AM, there is no need to break the link and repeat the process. However, doing so may result in additional impact events that have been entered into the impact event database 116 since the initial entry. Such variations in the method of FIG. 5 are contemplated within the scope of the present disclosure and other variations will occur to those skilled in the art upon consideration of the present teachings.

In other example implementations, official holiday impact events at a location associated with a calendar event can appear in the calendar in a manner similar to local holidays for the user's home location. So, for example, a person from Canada that schedules a calendar event in the United States on July 4 would see in their calendar an all day impact event that might appear in the calendar as “Independence Day (USA)” for that day. Additionally, a warning icon can be placed adjacent the description for the user's calendar event. For multi-day views (month, week), this can appear multiple times, one for each day of apparent conflict with the calendar event. In certain implementations, clicking or otherwise selecting the icon can initiate the display of a description of the conflict or a list of conflicts. This may be useful for smaller impact events or for showing multiple impact events without adding all the impact events to the calendar as separate events. In various user interfaces, one icon or multiple icons may be utilized without limitation. Icons may also be devised to convey various types of impact events such as airline, bus, hotel, etc. The events may also link to news that provides greater detail on the impact event or to services (for example, “transit strike in Paris” [news][book a rental car]”. Those skilled in the art will appreciate that many variations are possible in view of the present teachings.

The above example presumes a free-form entry of calendar events, but it will be clear to those skilled in the art upon consideration of the present teachings that calendar events may be more structured with fields designated for location including city, state, territory, country, etc. In such cases, incomplete entries can result in a deduction of a possible location that can be used to complete entry, so as to both provide a complete description of the event and associated calendaring information, as well as to facilitate the query discussed above to identify impact events. To assist the user, it is useful to provide selective or global overrides under user control. Alternatively, the search for impact events can be user invoked or rejected during the event creation process as desired.

Many variations can be devised for implementing a user interface (UI) for use in conjunction with various implementations. For example, a UI can be devised where the possible locations are presented in an auto-complete box rather than a separate dialog box. This can operate in a manner similar to a browser, search boxes or auto-complete text entry where the user can keep typing or pick one of a plurality of suggested items that appear, for example in a drop-down window, and which change as the user continues to type.

Many variations and modifications consistent with implementation of the present teachings may be made by those skilled in the art in light of the present teachings. For example, there is no reason why the subject matter could not be implemented at least in part on a desktop computing device or in a server of a cloud network. Often desktops have the location set (accurate to the city), or can determine it from the network.

It is also possible to add additional value to the user by not only warning that certain events could cause difficulties with travel and booking, but also to provide easy access to sources for ticket purchase or other travel arrangements when the location and/or date determined from the calendar event data suggests that travel is being contemplated. For example, the calendar program could automatically link to sources for a ticket purchase including corporate travel offices or other travel options, if applicable.

Additionally, the warnings could be sorted into categories. For example, one category might be things that could impact accommodations (hotel vacancies), another might be things that could impact transport (transit, road closures, holidays, etc.). Other categories will also occur to those skilled in the art upon consideration of the present teachings.

The order in which certain operations occur such as those represented by Blocks 640 and 644 is not critical, and these operations may occur in any order. Thus, while the blocks comprising the methods are shown as occurring in a particular order, it will be appreciated by those skilled in the art upon consideration of the present teachings that many of the blocks may be interchangeable and can occur in different orders than that shown without materially affecting the end results of the methods.

The implementations of the present disclosure described above are intended to be examples only. Those of skill in the art can effect alterations, modifications and variations to the particular example embodiments herein without departing from the intended scope of the present disclosure. Moreover, selected features from one or more of the above-described example embodiments can be combined to create alternative example embodiments not explicitly described herein.

It will be appreciated that any module or component disclosed herein that executes instructions may include or otherwise have access to non-transitory and tangible computer readable media such as storage media, computer storage media, or data storage devices (removable or non-removable) such as, for example, magnetic disks, optical disks, or tape data storage, where the term “non-transitory” is intended only to exclude propagating waves and signals and does not exclude volatile memory or memory that can be rewritten. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server, any component of or related to the network, backend, etc., or accessible or connectable thereto. Any application or module herein described may be implemented using computer readable/executable instructions that may be stored or otherwise held by such computer readable media.

The present disclosure may be embodied in other specific forms without departing from its spirit or essential characteristics. The described example embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method, comprising:
receiving a command to enter calendar event data, in a calendar program that stores calendar data running on a processor of a wireless mobile device;
determining, from the calendar event data, a location and a date associated with the calendar event;
searching a database for impact event data associated with an impact event occurring at or about the location and on or about the date;
after identifying the impact event data, storing linking data, linking the calendar event and the impact event in the calendar program's calendar data.

2. The method in accordance with claim 1, where the impact event comprises a holiday at the location.

3. The method in accordance with claim 1, where the impact event comprises an event known to affect transportation or lodging at the location.

4. The method in accordance with claim 1, where the database resides on a remote search engine server in wireless communication with the wireless mobile device.

5. The method in accordance with claim 1, further comprising after determining from the calendar event the location and the date, generating and displaying a list of possible locations determined from the calendar event for selection of a correct location.

6. The method in accordance with claim 5, where the list of possible locations is placed in an order for display, with the order of the list being determined at least in part by communication history of the wireless mobile device.

7. The method in accordance with claim 5, where the list of possible locations is placed in an order for display, with the order of the list being determined at least in part by a location history of the wireless mobile device.

8. The method in accordance with claim 5, where the list of possible locations is placed in an order for display, with the order of the list being determined at least in part by frequency of travel from a current location or a home location of the wireless mobile device.

9. The method in accordance with claim 5, where the list of possible locations is placed in an order for display, with the order of the list being determined at least in part by reference to a contact in a contact database, where the contact is determined from the calendar event.

10. The method in accordance with claim 5, where the list of possible locations is placed in an order for display, with the order of the list being determined at least in part by a city size.

11. The method in accordance with claim 1, further comprising generating an alert of potential conflict between the calendar event and the impact event.

12. The method in accordance with claim 11, where the alert includes a link to a service or details of the impact event or news relating to the impact event.

13. The method in accordance with claim 1, further comprising after the determining the location, displaying an auto-complete box of possible locations from which a correct location can be selected.

14. A search engine server, coupled to a communications network, that facilitates identification of impact events impacting a calendar event, comprising:
a database;
a processor, coupled to the database and configured to:
after receiving a search query for a specified date in a specified location, return impact event data associated with an impact event occurring at or about the specified location and on or about the specified date.

15. The server in accordance with claim 14, where the impact event comprises a holiday at the location.

16. The server in accordance with claim 14, where the impact event comprises an event known to affect transportation or lodging at the location.

17. The server in accordance with claim 14, where the search query is initiated by a wireless mobile device in communication with the search engine server.

18. A wireless mobile device, comprising:
a calendar program configured to store and manage calendar data;
a processor configured to:
receive an input to enter calendar event data;
determine from the calendar event data, a location and a date associated with the event;
search a database for impact event data associated with an impact event occurring at or about the location and on or about the date;
after identifying the impact event data,
store linking data, linking the calendar event and the linked impact event in the calendar program's calendar data.

19. The device in accordance with claim 18, where the impact event comprises a holiday at the location.

20. The device in accordance with claim 18, where the impact event comprises an event known to affect transportation or lodging at the location.

21. The device in accordance with claim 18, where the database resides at a remote server in wireless communication with the wireless mobile device.

22. The device in accordance with claim 18, where the processor is configured to generate and display a list of possible locations determined from the calendar event for selection of a correct location.

23. The device in accordance with claim 22, where the processor is configured to place the list of possible locations in an order for display, with the order of the list being determined at least in part by communication history of the wireless mobile device.

24. The device in accordance with claim 22, where the processor is configured to place the list of possible locations in an order for display, with the order of the list being determined at least in part by a location history of the wireless mobile device.

25. The device in accordance with claim 22, where the processor is configured to place the list of possible locations in an order for display, with the order of the list being determined at least in part by frequency of travel from a current location or a home location of the wireless mobile device.

26. The device in accordance with claim 22, where the processor is configured to place the list of possible locations in an order for display, with the order of the list being determined at least in part by reference to a contact in a contact database, where the contact is determined from the calendar event.

27. The device in accordance with claim 22, where the processor is configured to place the list of possible locations in an order for display, with the order of the list being determined at least in part by a city size.

28. The device in accordance with claim 18, where the processor is configured to generate an alert of potential conflict between the calendar event and the impact event.

29. The device in accordance with claim 18, where the alert includes a link to a service or details of the impact event or news relating to the impact event.

30. The device in accordance with claim 18, where the processor is configured to generate a display of an auto-complete box of possible locations from which a correct location can be selected.
